(19) United States
(12) Patent Application Publication
(10) Pub. No.: US 2019/0376565 A1
(43) Pub. Date: Dec. 12, 2019

(54) DRIVING FORCE DISTRIBUTION APPARATUS

(71) Applicant: JTEKT Corporation, Osaka-shi (JP)

(72) Inventors: Mikiharu OYABU, Chiryu-shi (JP); Yoshinori Suzuki, Okazaki-shi (JP); Yuji Tsuzuki, Chiryu-shi (JP); Hiroyuki Inoue, Anjo-shi (JP); Naoki Ootawara, Kariya-shi (JP); Yuji Niwa, Takahama-shi (JP); Takahiro Kubo, Takahama-shi (JP); Kazuteru Shinagawa, Kariya-shi (JP); Ryouichi Kubo, Kashihara-shi (JP)

(73) Assignee: JTEKT Corporation, Osaka-shi (JP)

(21) Appl. No.: 16/434,444

(22) Filed: Jun. 7, 2019

(30) Foreign Application Priority Data
Jun. 12, 2018 (JP) 2018-112263

(51) Int. Cl. F16D 13/74; F16H 48/19; F16D 13/64; F16D 21/06; F16D 25/10; F16D 25/12; F16D 25/0638

(52) U.S. Cl. CPC F16D 13/74; F16H 48/19; F16D 13/648; F16D 2021/0661; F16D 25/10; F16D 25/123; F16D 25/0638; F16D 21/06

(57) ABSTRACT

A driving force distribution apparatus distributes and outputs, to a first clutch hub and a second clutch hub, a driving force input from a driving source. The driving force distribution apparatus includes a clutch housing to which a driving force is input, a first multi-disc clutch disposed between the clutch housing and the first clutch hub, and a second multi-disc clutch disposed between the clutch housing and the second clutch hub. A first pressing mechanism that presses the first multi-disc clutch includes an annular pressing portion disposed between a bottom wall portion of the clutch housing and the first multi-disc clutch, legs inserted in insertion holes formed in the bottom wall portion, and a lubricating oil introduction portion that guides lubricating oil supplied from the clearance between the first clutch hub and the bottom wall portion toward the first multi-disc clutch.

### INCORPORATION BY REFERENCE

The disclosure of Japanese Patent Application No. 2018-112263 filed on Jun. 12, 2018 including the specification, drawings and abstract, is incorporated herein by reference in its entirety.

### BACKGROUND OF THE INVENTION

### 1. Field of the Invention

The present invention relates to a driving force distribution apparatus that distributes and outputs, to a plurality of output rotary members, a driving force input from a driving source.

### 2. Description of Related Art

Driving force distribution apparatuses have been used that distribute and output, to a plurality of output rotary members, a driving force input from a driving source. Theses driving force distribution apparatuses serve as differential apparatuses for vehicles. Some of the differential apparatuses can adjust a driving force to be transmitted to output rotary members, by using a multi-disc clutch including a plurality of clutch plates. See, for example, Japanese Patent Application Publication No. 2006-182242 (JP 2006-182242 A).

A driving force distribution apparatus (rear-wheel-side axle differential mechanism) described in JP 2006-182242 A is configured such that a driving force input to an input shaft is transmitted to a hollow shaft (holding member) via a bevel gear, and then transmitted from the shaft to a cylindrical clutch housing (clutch guide). The shaft and the clutch housing are non-rotatably coupled to each other by spline fitting. A right output member and a left output member are coaxially disposed inside the clutch housing. A right multi-disc clutch including a plurality of right input-side plates and right output-side plates is disposed between the clutch housing and the right output member. A left multi-disc clutch including a plurality of left input-side plates and left output-side plates is disposed between the clutch housing and the left output member.

The right output member and the left output member have a plurality of radial holes through which lubricating oil is supplied to the right and left multi-disc clutches. The lubricating oil lubricates the right input-side plates and right output-side plates, and the left input-side plates and left output-side plates, thereby reducing wear and heat generation.

In the driving force distribution apparatus with the configuration described above, the amount of lubricating oil supplied to the right and left multi-disc clutches may be increased by increasing the number of the radial holes, or by increasing the size of the radial holes. However, increasing the number or size of the radial holes may reduce the strength of the right output member and the left output member.

### SUMMARY OF THE INVENTION

An object of the present invention is to provide a driving force distribution apparatus that allows increasing the amount of lubricating oil supplied to a multi-disc clutch without reducing the strength of an output rotary member.

According to an aspect of the present invention, there is provided a driving force distribution apparatus that distributes and outputs, to first and second output rotary members, a driving force input from a driving source.

The driving force distribution apparatus includes:

a case member in which lubricating oil is stored;

a shaft that receives the driving force and rotates in the case member;

a clutch housing that is restrained from rotating relative to the shaft, the clutch housing including a cylindrical portion having a cylindrical shape, and a bottom wall portion extending radially inward from an axial end of the cylindrical portion;

a first multi-disc clutch including a plurality of clutch plates disposed between the cylindrical portion of the clutch housing and the first output rotary member;

a second multi-disc clutch including a plurality of clutch plates disposed between the cylindrical portion of the clutch housing and the second output rotary member;

a first pressing mechanism that presses the first multi-disc clutch; and

a second pressing mechanism that presses the second multi-disc clutch.

The first multi-disc clutch is disposed closer to the bottom wall portion in the clutch housing than the second multi-disc clutch is.

The first pressing mechanism includes a pressing member including legs inserted in insertion holes formed in the bottom wall portion of the clutch housing, and an annular pressing portion disposed between the bottom wall portion and the first multi-disc clutch.

The pressing member includes a lubricating oil introduction portion that guides the lubricating oil supplied from a clearance between the first output rotary member and the bottom wall portion toward the first multi-disc clutch.

According to the driving force distribution apparatus of the above aspect, it is possible to increase the amount of lubricating oil supplied to a multi-disc clutch without reducing the strength of an output rotary member.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a schematic configuration diagram illustrating an example of the configuration of a four-wheel drive vehicle with a driving force distribution apparatus mounted thereon according to an embodiment of the present invention;

FIG. 2 is a horizontal cross-sectional view of the entire driving force distribution apparatus mounted on a vehicle;

FIG. 3 is a vertical cross-sectional view of a part of the driving force distribution apparatus mounted on a vehicle;

FIG. 4 is a cross-sectional view of a main part of the driving force distribution apparatus;

FIG. 5A is a cross-sectional view of a hollow shaft and a first clutch hub taken along line A-A of FIG. 4;

FIG. 5B is a cross-sectional view of the hollow shaft, a clutch housing, and the first clutch hub taken along line B-B of FIG. 4;

FIG. 5C is a cross-sectional view of the first clutch hub taken along line C-C of FIG. 4, together with an end face of a stopper ring;

FIG. 6A is a plan view of a first outer clutch plate;

FIG. 6B is a plan view of a first inner clutch plate;

FIG. 7A is a plan view of a second outer clutch plate;

FIG. 7B is a plan view of a second inner clutch plate;

FIG. 8 is a perspective cross-sectional view of a pressing member;

FIG. 9A is an enlarged cross-sectional view of the area around the pressing member when the pressing member is pressing the first multi-disc clutch;

FIG. 9B is an enlarged cross-sectional view of the area around the pressing member when the pressing member is not pressing the first multi-disc clutch;

FIG. 10A illustrates a first modification of the pressing member; and

FIG. 10B illustrates a second modification of the pressing member.

### DETAILED DESCRIPTION OF EMBODIMENTS

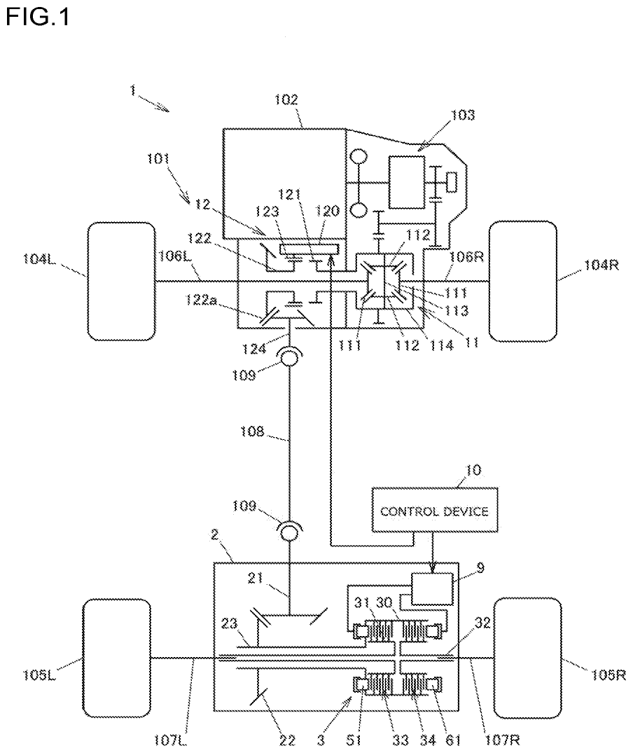

An embodiment of the present invention will be described with reference to FIGS. 1 to 9B.

FIG. 1 is a schematic configuration diagram illustrating an example of the configuration of a four-wheel drive vehicle with a driving force distribution apparatus mounted thereon according to the embodiment of the present invention.

A four-wheel drive vehicle 1 includes an engine 102, a transmission 103, front wheels 104R and 104L, rear wheels 105R and 105L, a driving force transmission system 101, and a control device 10. The engine 102 serves as a driving source that generates a driving force for traveling. The front wheels 104R and 104L serve as a pair of right and left main driving wheels. The rear wheels 105R and 105L serve as a pair of right and left auxiliary driving wheels. The driving force transmission system 101 transmits the driving force of the engine 102 to the front wheels 104R and 104L and the rear wheels 105R and 105L.

The four-wheel drive vehicle 1 is switchable between a four-wheel drive mode in which the driving force of the engine 102 is transmitted to the front wheels 104R and 104L and the rear wheels 105R and 105L and a two-wheel drive mode in which the driving force of the engine 102 is transmitted only to the front wheels 104R and 104L. In the present embodiment, the suffixes “R” and “L” of the reference symbols are used to represent “right” and “left” with respect to the vehicle.

The driving force transmission system 101 includes a front differential 11, a propeller shaft 108, a dog clutch 12, a driving force distribution apparatus 2, front-wheel drive shafts 106R and 106L, and rear-wheel drive shafts 107R and 107L. The propeller shaft 108 serves as a drive shaft that transmits the driving force of the engine 102 in a vehicle longitudinal direction. The dog clutch 12 allows or interrupts transmission of the driving force from the engine 102 to the propeller shaft 108. The driving force distribution apparatus 2 distributes the driving force from the propeller shaft 108 to the right and left rear wheels 105R and 105L in an adjustable manner. The driving force of the engine 102 is always transmitted to the front wheels 104R and 104L via the front-wheel drive shafts 106R and 106L. The driving force of the engine 102 is transmitted or prevented from being transmitted to the rear wheels 105R and 105L via the dog clutch 12, the propeller shaft 108, the driving force distribution apparatus 2, and the rear-wheel drive shafts 107R and 107L.

The control device 10 controls the dog clutch 12 and the driving force distribution apparatus 2. When the four-wheel drive vehicle 1 is in the four-wheel drive mode, the control device 10 controls the dog clutch 12 and the driving force distribution apparatus 2 to transmit the driving force to the rear wheels 105R and 105L. When the four-wheel drive vehicle 1 is in the two-wheel drive mode, the control device 10 controls the dog clutch 12 and the driving force distribution apparatus 2 to interrupt transmission of the driving force. Accordingly, when the four-wheel drive vehicle 1 is in the two-wheel drive mode, rotation of the propeller shaft 108 and other components is stopped. This increases the fuel efficiency.

The front differential 11 includes a pair of side gears 111, a pair of pinion gears 112, a pinion gear shaft 113, and a front differential case 114. The side gears 111 are respectively coupled to the front-wheel drive shafts 106R and 106L. The pinion gears 112 mesh with the side gears 111 with their gear axes orthogonal to each other. The pinion gear shaft 113 supports the pinion gears 112. The front differential case 114 houses the side gears 111, the pinion gears 112, and the pinion gear shaft 113. The driving force of the engine 102 with a speed changed by the transmission 103 is transmitted to the front differential case 114.

The dog clutch 12 includes a first rotary member 121, a second rotary member 122, a sleeve 123, and an actuator 120. The first rotary member 121 rotates together with the front differential case 114. The second rotary member 122 is arranged coaxially with the first rotary member 121. The sleeve 123 can non-rotatably couple the first rotary member 121 and the second rotary member 122. The actuator 120 is controlled by the control device 10. The actuator 120 moves the sleeve 123 between a coupled position where the sleeve 123 meshes with the first rotary member 121 and the second rotary member 122 and a decoupled position where the sleeve 123 meshes with only the second rotary member 122. When the sleeve 123 is located at the coupled position, the first rotary member 121 and the second rotary member 122 are non-rotatably coupled to each other. When the sleeve 123 is located at the decoupled position, the first rotary member 121 and the second rotary member 122 are rotatable relative to each other.

The propeller shaft 108 receives the driving force of the engine 102 from the front differential case 114 via the dog clutch 12, and transmits the driving force toward the driving force distribution apparatus 2. Two universal joints 109 are attached to respective two ends of the propeller shaft 108. The universal joint 109 on the front side of the vehicle couples a pinion gear shaft 124 to the propeller shaft 108. The pinion gear shaft 124 meshes with a ring gear portion 122a disposed on the second rotary member 122 of the dog clutch 12. The universal joint 109 on the rear side of the vehicle couples the propeller shaft 108 to a pinion gear shaft 21 of the driving force distribution apparatus 2.

The driving force distribution apparatus 2 includes the pinion gear shaft 21, a ring gear 22, a hollow shaft 23, a clutch mechanism unit 3, and a hydraulic unit 9. The pinion gear shaft 21 serves as an input rotary member. The ring gear 22 meshes with the pinion gear shaft 21 and rotates. The hollow shaft 23 has a hollow cylindrical shape, and rotates together with the ring gear 22. The clutch mechanism unit 3 allows or interrupts transmission of the driving force transmitted to the hollow shaft 23 to the rear-wheel drive shafts 107R and 107L. The hydraulic unit 9 supplies hydraulic oil to the clutch mechanism unit 3. The clutch mechanism unit 3 includes a clutch housing 30 that rotates together with the hollow shaft 23, and first and second clutch hubs 31 and 32 serving as first and second output rotary members. The clutch mechanism unit 3 distributes, to the first and second clutch hubs 31 and 32, the driving force input from the pinion gear shaft 21, and outputs the driving force to the drive shafts 107R and 107L.

In the four-wheel drive mode, the control device 10 controls the driving force distribution apparatus 2 such that the higher a differential rotational speed is, or the greater the amount by which the driver depresses an accelerator pedal is, the greater the driving force transmitted to the rear wheels 105R and 105L is, for example. The differential rotational speed is the difference between an average rotational speed of the front wheels 104R and 104L and an average rotational speed of the rear wheels 105R and 105L. Further, for example, when the vehicle turns, the control device 10 makes the driving force to be transmitted to the outer one of the rear wheels 105R and 105L on the curve greater than the driving force to be transmitted to the inner one on the curve so as to allow the vehicle to turn smoothly. Also, when oversteer or understeer occurs, the control device 10 performs stability control to stabilize the traveling state by adjusting the driving forces to be transmitted to the rear wheels 105R and 105L.

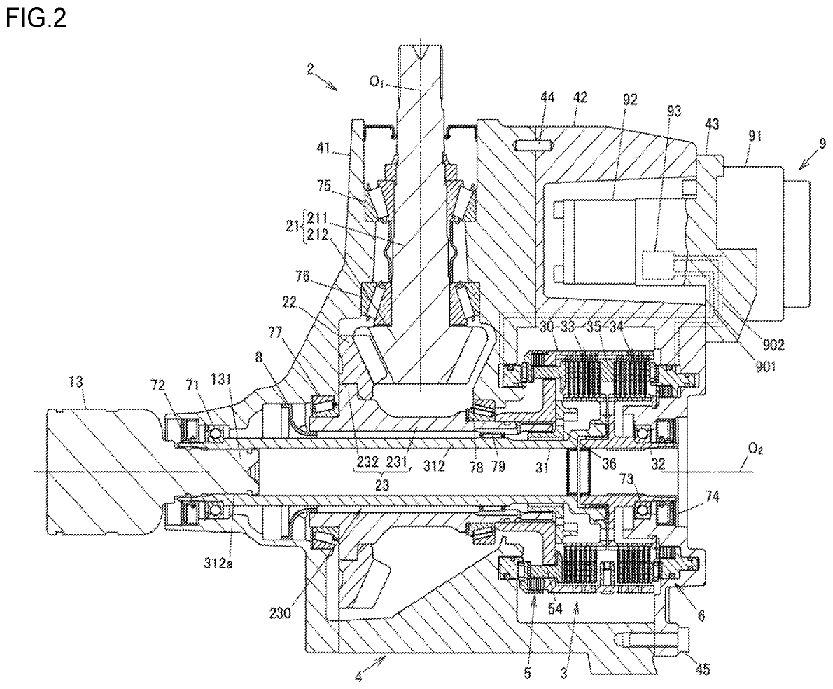

Hereinafter, the configuration of the driving force distribution apparatus 2 will be described in detail with reference to FIGS. 2 to 9B.

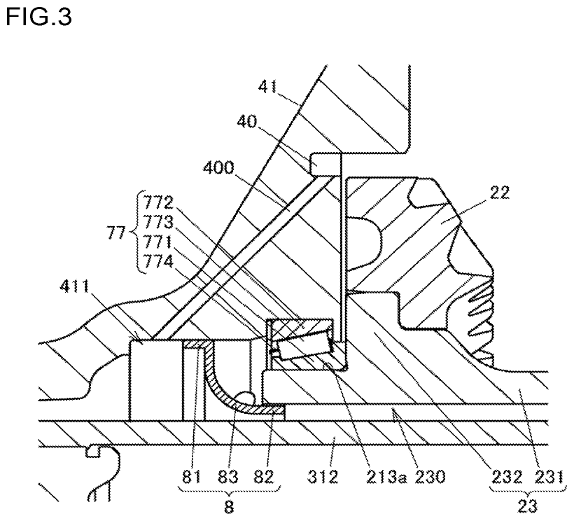

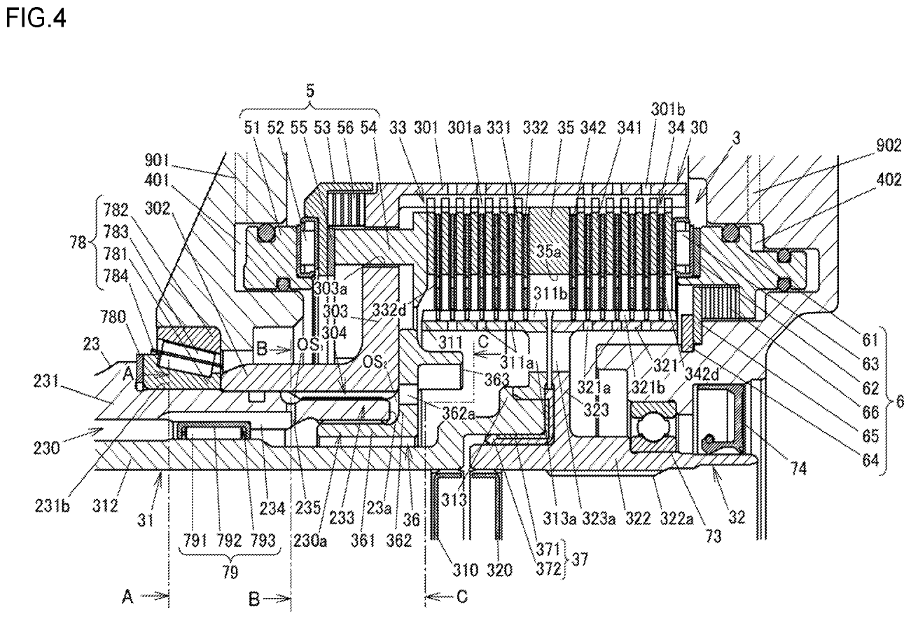

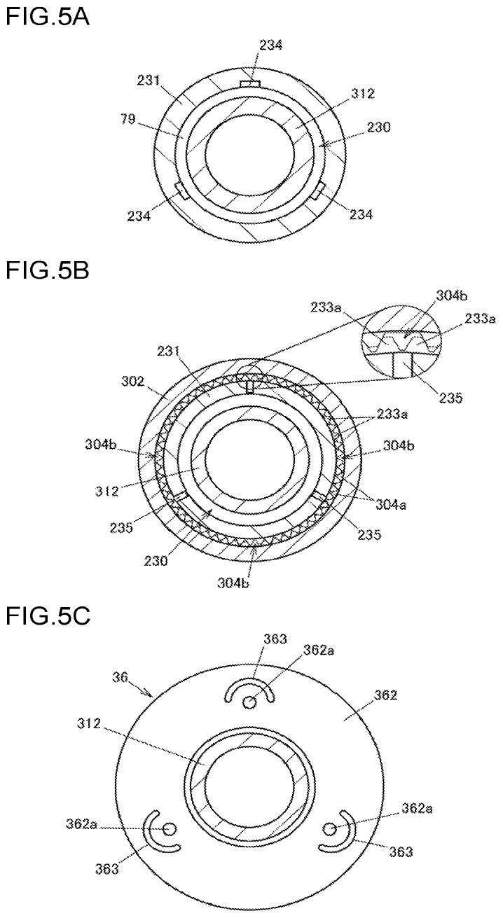

FIG. 2 is a horizontal cross-sectional view of the driving force distribution apparatus 2 mounted on a vehicle. FIG. 3 is a vertical cross-sectional view of the driving force distribution apparatus 2 mounted on a vehicle. FIG. 4 is a cross-sectional view of a main part of the driving force distribution apparatus 2. FIG. 5A is a cross-sectional view of the hollow shaft 23 and the first clutch hub 31 taken along line A-A of FIG. 4. FIG. 5B is a cross-sectional view of the hollow shaft 23, the clutch housing 30, and the first clutch hub 31 taken along line B-B of FIG. 4. FIG. 5C is a cross-sectional view illustrating a cross section of the first clutch hub 31 taken along line C-C of FIG. 4, together with an end face of a stopper ring 36 described later. In FIG. 3, the upper side of the drawing corresponds to the upper side in the vertical direction when the driving force distribution apparatus 2 is mounted on a vehicle.

The driving force distribution apparatus 2 includes a case member 4 fixed to a vehicle body. The case member 4 houses the pinion gear shaft 21, the ring gear 22, the hollow shaft 23, and the clutch mechanism unit 3. The case member 4 includes a case main body 41, a case lid body 42, and a support body 43 that supports the hydraulic unit 9. The case main body 41 and the case lid body 42 are coupled by a plurality of positioning pins 44 and bolts 45. In FIG. 2, one of the positioning pins 44 and one of the bolts 45 are illustrated. Lubricating oil (not illustrated) is introduced in the case member 4.

The clutch mechanism unit 3 includes a cylindrical clutch housing 30, the first clutch hub 31, the second clutch hub 32, a first multi-disc clutch 33, a second multi-disc clutch 34, a center plate 35, and the stopper ring 36. The clutch housing 30 is prevented from rotating relative to the hollow shaft 23. The first clutch hub 31 serves as a first output rotary member. The second clutch hub 32 serves as a second output rotary member. The first multi-disc clutch 33 is disposed between the clutch housing 30 and the first clutch hub 31. The second multi-disc clutch 34 is disposed between the clutch housing 30 and the second clutch hub 32. The center plate 35 serves as an intermediate member interposed between the first multi-disc clutch 33 and the second multi-disc clutch 34. The stopper ring 36 serves as a detachment stopper member that prevents the clutch housing 30 from being detached from the hollow shaft 23. The clutch mechanism unit 3 distributes and outputs, to the first clutch hub 31 and the second clutch hub 32, the driving force input to the clutch housing 30.

As illustrated in FIG. 4, the clutch housing 30 includes, as integral parts, a large-diameter cylindrical portion 301, a small-diameter cylindrical portion 302, and a bottom wall portion 303. The large-diameter cylindrical portion 301 has a cylindrical shape and houses the first and second multi-disc clutches 33 and 34. The small-diameter cylindrical portion 302 has a cylindrical shape and has a smaller diameter than the large-diameter cylindrical portion 301. The bottom wall portion 303 extends radially inward from an axial end of the large-diameter cylindrical portion 301, and connects the large-diameter cylindrical portion 301 and the small-diameter cylindrical portion 302. The bottom wall portion 303 has a plurality of insertion holes 303a. The first and second multi-disc clutches 33 and 34 are arranged in the axial direction in the large-diameter cylindrical portion 301 of the clutch housing 30. The first multi-disc clutch 33 is disposed closer to the bottom wall portion 303 in the clutch housing 30 than the second multi-disc clutch 34 is.

The first multi-disc clutch 33 includes a plurality of first outer clutch plates 331 and first inner clutch plates 332. The clutch plates 331 and 332 are alternately arranged. The second multi-disc clutch 34 includes a plurality of second outer clutch plates 341 and second inner clutch plates 342. The clutch plates 341 and 342 are alternately arranged. The center plate 35 is fixed to the inner surface of the large-diameter cylindrical portion 301 of the clutch housing 30 by welding, for example, and is prevented from moving with respect to the clutch housing 30 in the axial direction.

The first clutch hub 31 includes an outer cylindrical portion 311 facing the large-diameter cylindrical portion 301 of the clutch housing 30 in the radial direction, an inner cylindrical portion 312 having a spline fitting portion 312a on its inner periphery such that an end of the drive shaft 107L is non-rotatably fitted to the spline fitting portion 312a, and an end wall portion 313 disposed between the ends of the outer cylindrical portion 311 and inner cylindrical portion 312. In FIG. 2, an outer race 13 of a constant velocity joint as a part of the drive shaft 107L is illustrated. A stem portion 131 of the outer race 13 is fitted in the spline fitting portion 312a.

The second clutch hub 32 includes an outer cylindrical portion 321 facing the large-diameter cylindrical portion 301 of the clutch housing 30 in the radial direction, an inner cylindrical portion 322 having a spline fitting portion 322a on its inner periphery such that an end of the drive shaft 107R is non-rotatably fitted to the spline fitting portion 322a, and an end wall portion 323 disposed between the ends of the outer cylindrical portion 321 and inner cylindrical portion 322. A bushing 37 is attached to the end wall portion 313 of the first clutch hub 31. The bushing 37 includes a core 371 having an L-shaped cross section, and a resin portion 372 covering the core 371. The bushing 37 smoothens relative rotation between the first clutch hub 31 and the second clutch hub 32.

In the present embodiment, the first clutch hub 31 includes two members welded together at the end wall portion 313. However, the entire first clutch hub 31 may be a single integrally-molded member. In the present embodiment, the second clutch hub 32 is a single integrally-molded member. However, the second clutch hub 32 may include a plurality of members coupled by welding or other methods.

End caps 310 and 320 are attached to the inner cylindrical portion 312 of the first clutch hub 31 and the inner cylindrical portion 322 of the second clutch hub 32, respectively, to prevent leakage of lubricating oil. A ball bearing 71 and a seal member 72 are disposed between the outer periphery of the inner cylindrical portion 312 of the first clutch hub 31 and the inner surface of the opening of the case main body 41. A ball bearing 73 and a seal member 74 are disposed between the outer periphery of the inner cylindrical portion 322 of the second clutch hub 32 and the inner surface of the opening of the case lid body 42.

The outer cylindrical portion 311 of the first clutch hub 31 has a plurality of oil holes 311a through which lubricating oil flows. Also, the outer cylindrical portion 321 of the second clutch hub 32 has a plurality of oil holes 321a through which lubricating oil flows. The end wall portion 313 of the first clutch hub 31 and the end wall portion 323 of the second clutch hub 32 have a plurality of oil holes 313a and a plurality of oil holes 323a through which lubricating oil flows in the axial direction, respectively.

The large-diameter cylindrical portion 301 of the clutch housing 30 includes, on its inner periphery, a plurality of engagement projections 301a for engagement with the plurality of first outer clutch plates 331 and second outer clutch plates 341. The first outer clutch plates 331 and the second outer clutch plates 341 engage with the engagement projections 301a and are prevented from rotating relative to the large-diameter cylindrical portion 301. The large-diameter cylindrical portion 301 of the clutch housing 30 has a plurality of oil drain holes 301b such that lubricating oil that flows between the first outer clutch plates 331 and the first inner clutch plates 332 or between the second outer clutch plates 341 and the second inner clutch plates 342 is discharged from the clutch housing 30. The plurality of oil drain holes 301b are axially aligned in a plurality of circumferential positions.

The outer cylindrical portion 311 of the first clutch hub 31 includes, on its outer periphery, a plurality of engagement projections 311b for engagement with the plurality of first inner clutch plates 332 so as to prevent the first inner clutch plate 332 from rotating relative to the first clutch hub 31. The outer cylindrical portion 321 of the second clutch hub 32 includes, on its outer periphery, a plurality of engagement projections 321b for engagement with the plurality of second inner clutch plates 342 so as to prevent the second inner clutch plate 342 from rotating relative to the second clutch hub 32.

The first multi-disc clutch 33 transmits a driving force between the clutch housing 30 and the first clutch hub 31, by a frictional force between the first outer clutch plates 331 and the first inner clutch plates 332. The second multi-disc clutch 34 transmits a driving force between the clutch housing 30 and the second clutch hub 32, by a frictional force between the second outer clutch plates 341 and the second inner clutch plates 342.

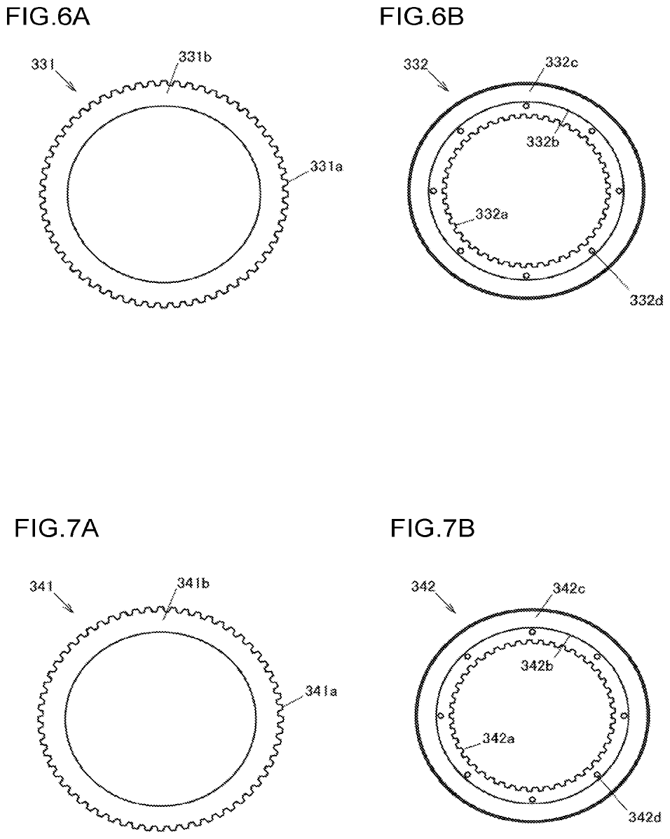

FIG. 6A is a plan view of the first outer clutch plate 331, and FIG. 6B is a plan view of the first inner clutch plate 332. FIG. 7A is a plan view of the second outer clutch plate 341, and FIG. 7B is a plan view of the second inner clutch plate 342.

The first outer clutch plate 331 has, at its outer peripheral edge, a plurality of projections 331a that engage with the engagement projections 301a of the clutch housing 30. The first inner clutch plate 332 has, at its inner peripheral edge, a plurality of projections 332a that engage with the engagement projections 311b of the first clutch hub 31. The first inner clutch plate 332 includes annular friction materials 332b on its side surfaces facing the first outer clutch plates 331. The surfaces of the friction materials 332b are frictional surfaces 332c. The first outer clutch plate 331 has frictional surfaces 331b defining its side surfaces facing the frictional surfaces 332c in the axial direction.

The first inner clutch plate 332 has, at its portion on the radially inner side with respect to the frictional surfaces 332c, a plurality of oil holes 332d axially extending therethrough and through which lubricating oil flows. The plurality of oil holes 332d are at least partially disposed on the radially inner side with respect to an inner peripheral face 35a of the center plate 35.

Similar to the first outer clutch plate 331, the second outer clutch plate 341 has, at its outer peripheral edge, a plurality of projections 341a that engage with the engagement projections 301a of the clutch housing 30. The second outer clutch plate 341 has frictional surfaces 341b defining its side surfaces facing frictional surfaces 342c of friction materials 342b of the second inner clutch plates 342.

The second inner clutch plate 342 has, at its inner peripheral edge, a plurality of projections 342a that engage with the engagement projections 321b of the second clutch hub 32. The second inner clutch plate 342 has, at its portion on the radially inner side with respect to the frictional surfaces 342c, a plurality of oil holes 342d axially extending therethrough and through which lubricating oil flows. The plurality of oil holes 342d are at least partially disposed on the radially inner side with respect to the inner peripheral face 35a of the center plate 35.

As illustrated in FIG. 4, the driving force distribution apparatus 2 includes a first pressing mechanism 5 that presses the first multi-disc clutch 33 against the center plate 35 to bring the first outer clutch plates 331 and the first inner clutch plates 332 into frictional contact with each other, and a second pressing mechanism 6 that presses the second multi-disc clutch 34 against the center plate 35 to bring the second outer clutch plates 341 and the second inner clutch plates 342 into frictional contact with each other.

The first pressing mechanism 5 includes a first piston 51, a thrust roller bearing 52, an annular pressure receiving member 53, a plurality of pressing members 54, a thrust washer 55, and a return spring 56. The first piston 51 receives hydraulic pressure supplied from the hydraulic unit 9 to a first cylinder 401 through a first oil path 901. The thrust roller bearing 52 abuts against the first piston 51. The thrust roller bearing 52 is held between the first piston 51 and the pressure receiving member 53. The pressing members 54 are partially inserted into the insertion holes 303a of the bottom wall portion 303 of the clutch housing 30. The thrust washer 55 is interposed between the pressure receiving member 53 and the plurality of pressing members 54. The return spring 56 is disposed and compressed between the bottom wall portion 303 of the clutch housing 30 and the pressure receiving member 53.

The second pressing mechanism 6 includes a second piston 61, a thrust washer 62 and a thrust roller bearing 63, a snap ring 64, a washer 65, and a return spring 66. The second piston 61 receives hydraulic pressure supplied from the hydraulic unit 9 to a second cylinder 402 through a second oil path 902. The thrust washer 62 and the thrust roller bearing 63 are disposed between the second piston 61 and the second multi-disc clutch 34. The snap ring 64 is fitted to the case lid body 42. The washer 65 abuts against the snap ring 64. The return spring 66 is disposed and compressed between the washer 65 and the second piston 61.

The pinion gear shaft 21 includes a shaft portion 211 supported by a pair of tapered roller bearings 75 and 76, and a gear portion 212 at one end of the shaft portion 211. The universal joint 109 on the rear side of the vehicle is coupled to another end of the shaft portion 211. The pinion gear shaft 21 rotates about a rotation axis O1 extending in the vehicle longitudinal direction. The gear portion 212 of the pinion gear shaft 21, and the ring gear 22 meshing with the gear portion 212 are, for example, hypoid gears. The ring gear 22 receives the driving force of the engine 102 from the pinion gear shaft 21. The hollow shaft 23 receives the driving force from the ring gear 22 and rotates in the case member 4.

The hollow shaft 23 includes, as integral parts, a cylindrical shaft portion 231, and a flange portion 232 to which the ring gear 22 is attached. The hollow shaft 23 rotates together with the ring gear 22 about a rotation axis O2 extending in a vehicle width direction. The flange portion 232 is formed to project radially outward from the shaft portion 231. The ring gear 22 is fixed, for example, by welding to the flange portion 232 such that the hollow shaft 23 rotates together with the ring gear 22. Hereinafter, a direction parallel to the rotation axis O2 will be referred to as an axial direction.

The hollow shaft 23 has a hollow portion 230 at the center of the shaft portion 231. The inner cylindrical portion 312 forming a part of the first clutch hub 31 is inserted into the hollow portion 230. A helical groove is formed in the inner periphery at an end of the hollow portion 230. The portion where the groove is formed is a screw hole 230a. That is, the hollow shaft 23 has the hollow portion 230 including the screw hole 230a at the center of the shaft portion 231. The hollow portion 230 extends axially through the shaft portion 231. The screw hole 230a is open at one axial end face 23a of the hollow shaft 23.

The hollow shaft 23 is supported in the case member 4 by a pair of tapered roller bearings 77 and 78. The outer periphery of the shaft portion 231 of the hollow shaft 23 includes bearing surfaces 231a and 231b to which inner rings 771 (see FIG. 3) and 781 of the tapered roller bearings 77 and 78 are fitted. The tapered roller bearings 77 and 78 include the inner rings 771 and 781, outer rings 772 and 782, a plurality of partially conical rollers 773 and 783, and cages 774 and 784 holding the plurality of rollers 773 and 783, respectively. The tapered roller bearings 77 and 78 are disposed away from each other in the axial direction, with the flange portion 232 interposed therebetween. The hollow shaft 23 is positioned with respect to the case member 4 in the axial direction, and is rotatably supported by the tapered roller bearings 77 and 78.

A radial roller bearing 79 is disposed between the inner periphery of the hollow shaft 23 and the inner cylindrical portion 312 of the first clutch hub 31. The radial roller bearing 79 includes a plurality of rollers 791 that roll on the outer periphery of the inner cylindrical portion 312, an annular shell 792 covering the outer side of the rollers 791, and a cage 793 holding the rollers 791. The radial roller bearing 79 is disposed on the ring gear 22 side with respect to the screw hole 230a. The radial roller bearing 79 reduces radial oscillation of the first clutch hub 31 about a part supported by the ball bearing 71.

An oil guide member 8 with a funnel shape is disposed on the outer peripheral side of the inner cylindrical portion 312 of the first clutch hub 31. As illustrated in FIG. 3, the oil guide member 8 includes, as integral parts, a proximal end cylindrical portion 81, a distal end cylindrical portion 82, and an inclined portion 83. The proximal end cylindrical portion 81 is press-fitted into a fitting hole 411 in the case main body 41. The distal end cylindrical portion 82 is inserted into the hollow portion 230 of the hollow shaft 23. The inclined portion 83 has a diameter that decreases from the proximal end cylindrical portion 81 toward the distal end cylindrical portion 82. The outer periphery of the distal end cylindrical portion 82 faces the inner periphery of the hollow portion 230 with a small clearance therebetween. The inner periphery of the distal end cylindrical portion 82 faces the outer periphery of the inner cylindrical portion 312 of the first clutch hub 31 with a clearance therebetween that is greater than the clearance from the inner periphery of the hollow portion 230.

The hollow shaft 23 has, at a clutch-mechanism-portion-3-side end on the outer periphery of the shaft portion 231, an outer peripheral engagement portion 233 for non-rotatably coupling the clutch housing 30 thereto. Meanwhile, the clutch housing 30 has, on the inner periphery of the small-diameter cylindrical portion 302, an inner peripheral engagement portion 304 that engages with the outer peripheral engagement portion 233 in the circumferential direction. As illustrated in FIG. 5B, the outer peripheral engagement portion 233 includes a plurality of spline projections 233a, and the inner peripheral engagement portion 304 includes a plurality of spline projections 304a. The spline projections 233a and 304a extend parallel to each other in the axial direction. The inner peripheral engagement portion 304 engages with the outer peripheral engagement portion 233 to prevent rotation of the clutch housing 30 relative to the hollow shaft 23.

The clutch housing 30 is prevented from coming off from the hollow shaft 23 by the stopper ring 36. The small-diameter cylindrical portion 302 is held between the inner ring 781 of the tapered roller bearing 78 and the stopper ring 36, so that the axial position of the clutch housing 30 in the case member 4 is fixed. The axial position of the inner ring 781 with respect to the hollow shaft 23 is adjusted by a shim 780.

The stopper ring 36 includes an external thread 361, an opposing wall portion 362, and a plurality of protrusions 363. The external thread 361 is screwed into the screw hole 230a of the hollow shaft 23. The opposing wall portion 362 projects radially outward beyond the outer periphery of the hollow shaft 23 and faces the small-diameter cylindrical portion 302 and the bottom wall portion 303 of the clutch housing 30. The protrusions 363 have distal ends on the inner side of the first multi-disc clutch 33. The external thread 361 of the stopper ring 36 is fastened into the screw hole 230a until the opposing wall portion 362 abuts against the small-diameter cylindrical portion 302 and the bottom wall portion 303 of the clutch housing 30.

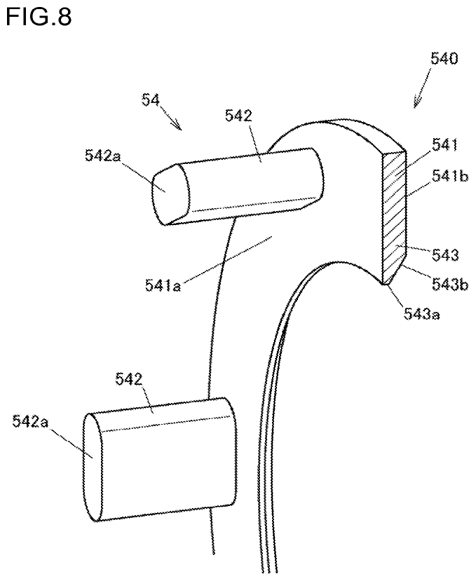

FIG. 8 is a perspective view of the pressing member 54 of the first pressing mechanism 5. The pressing member 54 includes an annular pressing portion 541, a plurality of legs 542, and a lubricating oil introduction portion 543. The pressing portion 541 is disposed between the bottom wall portion 303 of the clutch housing 30 and the first multi-disc clutch 33. The legs 542 are disposed upright on the pressing portion 541. The lubricating oil introduction portion 543 is disposed on the radially inner side of the pressing portion 541. The inner diameter and the outer diameter of the pressing portion 541 are equal to the inner diameter and the outer diameter of the frictional surfaces 331b of the first outer clutch plates 331 and the friction materials 332b of the first inner clutch plates 332. The first multi-disc clutch 33 receives an axial pressing force from the pressing portion 541 of the pressing member 54, so that the frictional surfaces 331b of the first outer clutch plates 331 and the frictional surfaces 332c of the first inner clutch plates 332 are brought into frictional contact with each other.

The plurality of legs 542 are disposed vertically upright on an opposing surface 541a that is one axial end face of the pressing portion 541 facing the bottom wall portion 303. Another axial end face of the pressing portion 541 is a pressing surface 541b that presses the first multi-disc clutch 33. In the present embodiment, the pressing surface 541b faces the first outer clutch plates 331.

The lubricating oil introduction portion 543 is provided integrally with the pressing portion 541, on the radially inner side of the pressing portion 541. The lubricating oil introduction portion 543 and the pressing portion 541 form an annular plate-shaped plate member 540. The lubricating oil introduction portion 543 is a radially inner portion of the plate member 540 that does not press the first multi-disc clutch 33. More specifically, the lubricating oil introduction portion 543 is a portion of the plate member 540 on the inner side with respect to the first outer clutch plates 331.

The plurality of legs 542 are inserted into the plurality of insertion holes 303a axially extending through the bottom wall portion 303 of the clutch housing 30, respectively. End faces 542a of the legs 542 abut against the thrust washer 55. As the legs 542 are inserted into the insertion holes 303a of the bottom wall portion 303, the pressing member 54 is prevented from rotating relative to the clutch housing 30, and is movable with respect to the clutch housing 30 in the axial direction.

The lubricating oil introduction portion 543 guides the lubricating oil introduced from the clearance between the first clutch hub 31 and the bottom wall portion 303 of the clutch housing 30 toward the first multi-disc clutch 33. The lubricating oil introduction portion 543 includes, on its inner periphery, an inner peripheral face 543a disposed at a bottom-wall-portion-303-side end thereof and parallel to the axial direction, and a tapered face 543b disposed closer to the first multi-disc clutch 33 than the inner peripheral face 543a is. The tapered face 543b is a surface inclined with respect to the axial direction such that its inner diameter gradually increases from the bottom wall portion 303 side toward the first clutch hub 31. The operation of the lubricating oil introduction portion 543 will be described below.

The hydraulic unit 9 includes an electric motor 91 that generates a torque corresponding to a motor current output from the control device 10, a hydraulic pump 92 operated by the electric motor 91, and a hydraulic circuit 93 that supplies hydraulic oil discharged from the hydraulic pump 92 to the first and second oil paths 901 and 902. The hydraulic circuit 93 includes a control valve (not illustrated) whose valve opening changes in accordance with a control current output from the control device 10. The first and second oil paths 901 and 902 are defined by holes formed in the case main body 41, the case lid body 42, and the support body 43.

The control device 10 outputs a motor current and a control current so as to supply hydraulic oil at an appropriate pressure to the first and second oil paths 901 and 902, in accordance with the driving mode of the four-wheel drive vehicle 1. For example, when the vehicle turns left, the pressure of hydraulic oil to be supplied to the first oil path 901 is increased so as to increase the driving force to be transmitted from the first multi-disc clutch 33 to the first clutch hub 31. When the vehicle turns right, the pressure of hydraulic oil to be supplied to the second oil path 902 is increased so as to increase the driving force to be transmitted from the second multi-disc clutch 34 to the second clutch hub 32. Further, for example, when the four-wheel drive mode is selected by a selecting operation by the driver, both the pressures of hydraulic oil supplied to the first and second oil paths 901 and 902 are increased to place the four-wheel drive vehicle 1 into the four-wheel drive mode.

The following describes a lubricating structure that supplies lubricating oil to the first and second multi-disc clutches 33 and 34. The lubricating oil picked up by rotation of the ring gear 22 is supplied to the first and second multi-disc clutches 33 and 34 through a path described below, and lubricates the first outer clutch plates 331 and the first inner clutch plates 332 that slide with friction, and the second outer clutch plates 341 and the second inner clutch plates 342 that slide with friction.

When the ring gear 22 rotates in the case member 4, lubricating oil stored in the lower part of the case member 4 is picked up. Part of the lubricating oil picked up is introduced into a catch tank 40 illustrated in FIG. 3. The lubricating oil introduced in the catch tank 40 flows down through an oil path 400 communicating with the catch tank 40, and is supplied to the outer peripheral side of the inner cylindrical portion 312 of the first clutch hub 31 on the drive shaft 107L side with respect to the oil guide member 8 (the side opposite to the ring gear 22).

Part of the lubricating oil supplied to the outer peripheral side of the inner cylindrical portion 312 of the first clutch hub 31 flows from the inner side of the distal end cylindrical portion 82 of the oil guide member 8 into the clearance between the hollow shaft 23 and the inner cylindrical portion 312 of the first clutch hub 31. The lubricating oil is prevented from flowing from the clearance between the hollow shaft 23 and the inner cylindrical portion 312 of the first clutch hub 31 toward the drive shaft 107L by the oil guide member 8.

The shaft portion 231 of the hollow shaft 23 has a plurality of oil grooves 234 in the inner periphery of the hollow portion 230 facing the radial roller bearing 79 to allow lubricating oil to flow toward the clutch mechanism unit 3 in the axial direction. In the example illustrated in FIG. 5A, the shaft portion 231 has three oil grooves 234 at equal intervals in the circumferential direction. However the number of oil grooves 234 is not limited.

Further, the hollow shaft 23 has a plurality of through holes 235 extending between the inner periphery and the outer periphery of the shaft portion 231. In the present embodiment, as illustrated in FIG. 5B, three through holes 235 are formed at equal intervals in the circumferential direction, and the through holes 235 respectively communicate with the oil grooves 234. The through holes 235 are formed on the ring gear 22 side with respect to the screw hole 230a in the axial direction, more specifically, between the radial roller bearing 79 and the screw hole 230a. In other words, the radial roller bearing 79 is disposed on the ring gear 22 side with respect to the through holes 235.

The lubricating oil in the through holes 235 flows from the inner periphery toward the outer periphery of the shaft portion 231 due to centrifugal force generated by rotation of the hollow shaft 23. The through holes 235 are open on the outer periphery on the ring gear 22 side with respect to the inner peripheral engagement portion 304 and the outer peripheral engagement portion 233. The lubricating oil that flows through the through holes 235 is supplied to the first and second multi-disc clutches 33 and 34 through the clearance between the small-diameter cylindrical portion 302 of the clutch housing 30 and the hollow shaft 23.

In the present embodiment, the inner peripheral engagement portion 304 of the clutch housing 30 has four toothless portions 304b (see FIG. 5B) having no spline projections 304a such that lubricating oil flows through the toothless portions 304b. Alternatively, the outer peripheral engagement portion 233 of the hollow shaft 23 may have toothless portions, or both the inner peripheral engagement portion 304 and the outer peripheral engagement portion 233 may have toothless portions. That is, at least one of the inner peripheral engagement portion 304 and the outer peripheral engagement portion 233 has to have toothless portions.

An annular first oil reservoir OS1 communicating with the through holes 235 and the toothless portions 304b is formed between the hollow shaft 23 and the small-diameter cylindrical portion 302 of the clutch housing 30. The lubricating oil that flows through the through holes 235 flows into the toothless portions 304b via the first oil reservoir OS1. The first oil reservoir OS1 allows lubricating oil to flow smoothly even when the positions of the through holes 235 and the positions of the toothless portions 304b are shifted in the circumferential direction.

The opposing wall portion 362 of the stopper ring 36 has flow holes 362a axially extending through the opposing wall portion 362 and through which the lubricating oil that flows between the small-diameter cylindrical portion 302 of the clutch housing 30 and the hollow shaft 23 flows. In the example illustrated in FIG. 5C, three flow holes 362a are formed in the opposing wall portion 362 at equal intervals in the circumferential direction. An annular second oil reservoir OS2 communicating with the flow holes 362a of the opposing wall portion 362 and the toothless portions 304b is formed between the small-diameter cylindrical portion 302 of the clutch housing 30 and the opposing wall portion 362 of the stopper ring 36. The second oil reservoir OS2 allows lubricating oil to flow smoothly even when the positions of the toothless portions 304b and the positions of the flow holes 362a are shifted in the circumferential direction.

The protrusions 363 of the stopper ring 36 are disposed on the radially outer side with respect to the openings of the flow holes 362a of the opposing wall portion 362 on the side opposite to the hollow shaft 23. In the present embodiment, three protrusions 363 respectively corresponding to the three flow holes 362a are formed to protrude axially from the opposing wall portion 362 toward the clearance between the outer cylindrical portion 311 and the inner cylindrical portion 312 of the first clutch hub 31. When lubricating oil is scattered from the distal ends of the protrusions 363 in the protruding direction due to the centrifugal force, the lubricating oil is adhered to the inner periphery of the outer cylindrical portion 311.

Part of the lubricating oil adhered to the inner periphery of the outer cylindrical portion 311 is supplied through the oil holes 311a of the outer cylindrical portion 311 to the first multi-disc clutch 33. Other part of the lubricating oil adhered to the inner periphery of the outer cylindrical portion 311 is supplied through the oil holes 313a of the end wall portion 313 of the first clutch hub 31 and the oil holes 323a of the end wall portion 323 of the second clutch hub 32, or through the clearance between the end wall portions 313 and 323, to the second multi-disc clutch 34. Further, other part of the lubricating oil adhered to the inner periphery of the outer cylindrical portion 311 is scattered from the clearance between the outer cylindrical portion 311 of the first clutch hub 31 and the bottom wall portion 303 of the clutch housing 30 to the lubricating oil introduction portion 543 of the pressing member 54 by the centrifugal force. The lubricating oil scattered and supplied to the lubricating oil introduction portion 543 is guided toward the first multi-disc clutch 33.

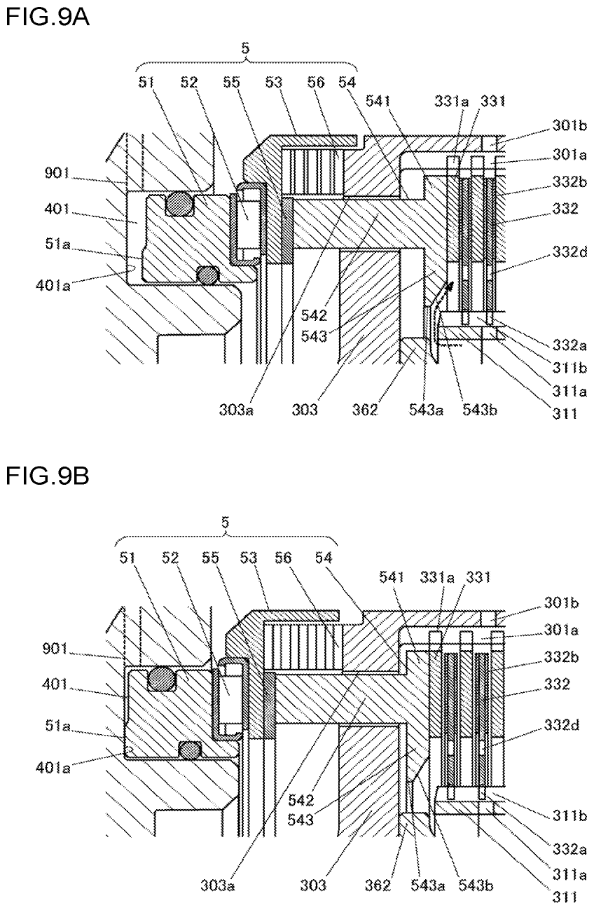

FIGS. 9A and 9B are enlarged cross-sectional views of the area around the pressing member 54. Specifically, FIG. 9A illustrates a state where the pressing member 54 is pressing the first multi-disc clutch 33, and FIG. 9B illustrates a state where the pressing member 54 is not pressing the first multi-disc clutch 33.

The first pressing mechanism 5 is configured such that a pressing force received by the first piston 51 from the hydraulic oil supplied to the first cylinder 401 is transmitted to the thrust roller bearing 52, the pressure receiving member 53, and the thrust washer 55 to the pressing member 54. The first multi-disc clutch 33 is pressed by the pressing member 54, so that the frictional surfaces 331b of the first outer clutch plates 331 and the frictional surfaces 332c of the first inner clutch plates 332 are pressed against each other, generating a frictional force.

When supply of hydraulic pressure to the first cylinder 401 is blocked, the first piston 51, the thrust roller bearing 52, and the pressure receiving member 53 retract until an abutment surface 51a of the first piston 51 abuts against the bottom surface of the first cylinder 401 due to the restoring force of the return spring 56. This allows relative rotation of the first outer clutch plates 331 and the first inner clutch plates 332 of the first multi-disc clutch 33.

As illustrated in FIGS. 9A and 9B, the lubricating oil introduction portion 543 of the pressing member 54 is always at least partially disposed on the bottom wall portion 303 side in the clutch housing 30 with respect to an end of the outer cylindrical portion 311 of the first clutch hub 31 (an end on the side opposite to the end wall portion 313). As indicated by the dashed arrow in FIG. 9A, lubricating oil scattered from the end of the outer cylindrical portion 311 is guided by the tapered face 543b of the lubricating oil introduction portion 543 to flow toward the first multi-disc clutch 33.

When the pressing member 54 presses the first multi-disc clutch 33, the lubricating oil that flows from the lubricating oil introduction portion 543 toward the first multi-disc clutch 33 flows through the oil holes 332d of the first inner clutch plate 332 in the axial direction. In this step, since the frictional surfaces 331b of the first outer clutch plates 331 and the frictional surfaces 332c of the first inner clutch plates 332 are in frictional contact with each other, the lubricating oil does not easily flow between the frictional surfaces 331b and 332c, and therefore flows toward the center plate 35.

Part of lubricating oil flows across the center plate 35 toward the second multi-disc clutch 34, and further flows in the axial direction through the oil holes 342d of the second inner clutch plates 342. While flowing in the axial direction, lubricating oil gradually flows between the first outer clutch plates 331 and the first inner clutch plates 332, and between the second outer clutch plates 341 and the second inner clutch plates 342.

The oil holes 332d of the first inner clutch plates 332 and the oil holes 342d of the second inner clutch plates 342 are at least partially disposed on the radially outer side with respect to the large-diameter-side end of the tapered face 543b of the lubricating oil introduction portion 543. Further, the oil holes 332d and 342d are at least partially disposed on the radially inner side with respect to the inner peripheries of the first outer clutch plates 331 and the second outer clutch plates 341. Thus, lubricating oil guided by the lubricating oil introduction portion 543 is supplied to the components of the first multi-disc clutch 33 and the second multi-disc clutch 34.

The inner diameter of the inner peripheral face 35a of the center plate 35 is greater than the diameter of the large-diameter-side end of the tapered face 543b, so that lubricating oil introduced by the lubricating oil introduction portion 543 can easily flow across the center plate 35 toward the second multi-disc clutch 34.

According to the embodiment described above, the lubricating oil supplied from the clearance between the first clutch hub 31 and the bottom wall portion 303 of the clutch housing 30 is guided toward the first multi-disc clutch 33 by the lubricating oil introduction portion 543. Accordingly, it is possible to supply lubricating oil from the clearance between the first clutch hub 31 and the large-diameter cylindrical portion 301 of the clutch housing 30 to the first multi-disc clutch 33. This makes it possible to increase the amount of lubricating oil supplied to the first multi-disc clutch 33, without reducing the strength of the first clutch hub 31 due to an increase in the number of oil holes 311a of the outer cylindrical portion 311, for example.

Further, according to the present embodiment, lubricating oil can flow in the axial direction through the oil holes 332d of the first inner clutch plates 332 and the oil holes 342d of the second inner clutch plates 342. Therefore, it is possible to supply lubricating oil to a large area in the axial direction.

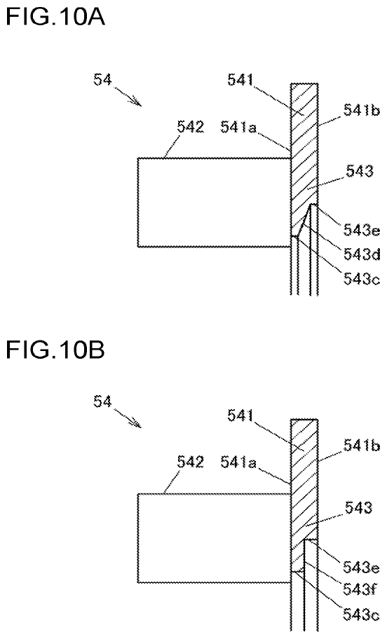

In the following, modifications of the lubricating oil introduction portion 543 of the pressing member 54 will be described with reference to FIGS. 10A and 10B FIG. 10A illustrates a first modification of the pressing member 54, and FIG. 10B illustrates a second modification of the pressing member 54.

A lubricating oil introduction portion 543 of the pressing member 54 of the first modification includes, on its inner periphery, a small-diameter inner peripheral face 543c at the bottom-wall-portion-303-side end thereof, a tapered face 543d disposed closer to the first multi-disc clutch 33 than the small-diameter inner peripheral face 543c is, and a large-diameter inner peripheral face 543e at the first-multi-disc-clutch-33-side end thereof. The tapered face 543d has an inner diameter that gradually increases from the small-diameter inner peripheral face 543c toward the large-diameter inner peripheral face 543e. The small-diameter inner peripheral face 543c and the large-diameter inner peripheral face 543e are surfaces parallel to the axial direction.

A lubricating oil introduction portion 543 of the pressing member 54 of the second modification includes, on its inner periphery, a small-diameter inner peripheral face 543c at the bottom-wall-portion-303-side end thereof, and a large-diameter inner peripheral face 543e at the first-multi-disc-clutch-33-side end thereof. A step surface 543f perpendicular to the axial direction is formed between the small-diameter inner peripheral face 543c and the large-diameter inner peripheral face 543e.

As in the case of the pressing member 54 illustrated in FIG. 8 and other figures, the pressing member 54 of each of the first and second modifications can guide lubricating oil toward the first multi-disc clutch 33. The oil holes 332d and 342d of the first and second inner clutch plates 332 and 342 are at least partially formed on the radially outer side with respect to the large-diameter inner peripheral face 543e of the pressing member 54 of each of the first and second modifications. Thus, it is possible to guide lubricating oil in the axial direction efficiently.

Various modifications may be made to the invention without departing from the scope of the invention. For example, in the above embodiment, the first and second multi-disc clutches 33 and 34 are pressed by the first and second pistons 51 and 61 that receive a hydraulic pressure. However, the present invention is not limited thereto. The first and second multi-disc clutches 33 and 34 may be pressed, for example, by the axial cam thrust converted from the rotational force of an electric motor by a cam mechanism. The configuration of the four-wheel drive vehicle 1 is not limited to that illustrated in FIG. 1.

What is claimed is:

1. A driving force distribution apparatus that distributes and outputs, to first and second output rotary members, a driving force input from a driving source, the driving force distribution apparatus comprising:
a case member in which lubricating oil is stored;
a shaft that receives the driving force and rotates in the case member;
a clutch housing that is restrained from rotating relative to the shaft, the clutch housing including a cylindrical portion having a cylindrical shape, and a bottom wall portion extending radially inward from an axial end of the cylindrical portion;
a first multi-disc clutch including a plurality of clutch plates disposed between the cylindrical portion of the clutch housing and the first output rotary member;
a second multi-disc clutch including a plurality of clutch plates disposed between the cylindrical portion of the clutch housing and the second output rotary member;
a first pressing mechanism that presses the first multi-disc clutch; and
a second pressing mechanism that presses the second multi-disc clutch; wherein
the first multi-disc clutch is disposed closer to the bottom wall portion in the clutch housing than the second multi-disc clutch is;
the first pressing mechanism includes a pressing member including legs inserted in insertion holes formed in the bottom wall portion of the clutch housing, and an annular pressing portion disposed between the bottom wall portion and the first multi-disc clutch; and
the pressing member includes a lubricating oil introduction portion that guides the lubricating oil supplied from a clearance between the first output rotary member and the bottom wall portion toward the first multi-disc clutch.

2. The driving force distribution apparatus according to claim 1, wherein the lubricating oil introduction portion of the pressing member is disposed on a radially inner side of the pressing portion.

3. The driving force distribution apparatus according to claim 1, wherein the lubricating oil introduction portion includes, on an inner periphery of the lubricating oil introduction portion, a tapered face having an inner diameter gradually increasing from a bottom wall portion side toward the first output rotary member.

4. The driving force distribution apparatus according to claim 1, wherein the lubricating oil introduction portion includes, on an inner periphery of the lubricating oil introduction portion, a large-diameter inner peripheral face and a small-diameter inner peripheral face having different inner diameters, the large-diameter inner peripheral face being disposed closer to the first multi-disc clutch than the small-diameter inner peripheral face is.

5. The driving force distribution apparatus according to claim 3, wherein:
each of the first multi-disc clutch and the second multi-disc clutch includes a plurality of outer clutch plates and a plurality of inner clutch plates that are alternately arranged, the outer clutch plates being engaged with the clutch housing;
the inner clutch plates have oil holes, that allow the lubricating oil to flow, on a radially inner side with respect to frictional surfaces of the inner clutch plates that are brought into frictional contact with the outer clutch plates; and
each of the oil holes is at least partially disposed on a radially outer side with respect to a large-diameter-side end of the tapered face.

6. The driving force distribution apparatus according to claim 4, wherein:
each of the first multi-disc clutch and the second multi-disc clutch includes a plurality of outer clutch plates and a plurality of inner clutch plates that are alternately arranged, the outer clutch plates being engaged with the clutch housing;
the inner clutch plates have oil holes, that allow the lubricating oil to flow, on a radially inner side with respect to frictional surfaces of the inner clutch plates that are brought into frictional contact with the outer clutch plates; and
each of the oil holes is at least partially disposed on a radially outer side with respect to the large-diameter inner peripheral face.

7. The driving force distribution apparatus according to claim 5, wherein:
an annular intermediate member is disposed between the first multi-disc clutch and the second multi-disc clutch, and is restrained from moving in an axial direction with respect to the clutch housing; and
each of the oil holes is at least partially disposed on a radially inner side with respect to an inner periphery of the intermediate member.
